(19) United States
(12) Patent Application Publication
(10) Pub. No.: US 2012/0279872 A1
(43) Pub. Date: Nov. 8, 2012

(54) METHOD AND SYSTEM FOR COMBINED PHOTOCATALYTIC AND ELECTROCHEMICAL WASTEWATER REMEDIATION

(75) Inventors: Aicheng Chen, Thunder Bay (CA); Robert Matthew Asmussen, Schreiber (CA); Min Tian, Thunder Bay (CA)

(73) Assignee: LAKEHEAD UNIVERSITY, Thunder Bay, ON (CA)

(21) Appl. No.: 13/321,425

(22) PCT Filed: May 19, 2010
(86) PCT No.: PCT/CA2010/000763

§ 371 Date: Jul. 16, 2012

Related U.S. Application Data
(60) Provisional application No. 61/213,241, filed on May 20, 2009.

(51) Int. Cl. C25B 11/06; C25B 11/03; C25B 11/08; C02F 1/467

(52) U.S. Cl. 205/758; 204/291; 204/242; 205/759

(57) ABSTRACT

The present invention utilizes the marriage of photocatalytic degradation and electrochemical oxidation to provide wastewater remediation and water purification based on the use of bifunctional electrodes. The bifunctional electrode provides for combined photocatalytic and electrochemical wastewater remediation for removing any one or combination of organic chemical pollutants, inorganic chemical pollutants and microorganisms. The electrode includes an electronically conducting substrate having a photocatalyst applied to a portion of the surface, the photocatalyst having a bandgap energy (E_{g}), and an electrocatalyst applied to another portion of the surface. Under illumination the photocatalyst produces electron-hole pairs which are separated by an anodic bias potential applied across the photocatalyst. The same bias is applied across the electrocatalyst. The application of the anodic potential bias not only greatly enhances the performance of the photocatalyst for photooxidation of pollutants at the photocatalyst, but also effectively drives electrochemical oxidation of pollutants at the electrocatalyst surface.

### FIELD OF THE INVENTION

The present invention relates to a method and system for wastewater treatment and water purification using bifunctional electrodes configured for combined photocatalytic and electrochemical remediation.

### BACKGROUND OF THE INVENTION

The establishment and enforcement of limits for the discharge and/or disposal of toxic and hazardous materials has required the development of new technologies to effectively remediate a variety of gaseous and liquid effluents, solid waste and sludge. Photocatalysis and electrochemistry have been gaining considerable attention owing to their promising applications in water disinfection and hazardous waste remediation (1-4).

In the removal of pollutants from waste effluents, a number of methods have been studied including electrochemical oxidation (5-9), chemical adsorption (10, 11) and photocatalytic degradation (12-16). In photocatalytic degradation, titania (TiO₂) is considered as one of the most promising photocatalysts due to its low cost, high photocatalytic activity and chemical stability (17-19). Upon irradiation with UV light, photoexcitation promotes electrons from the valence band to the conduction band of a photocatalyst, leaving highly oxidizing photogenerated holes behind (20-23). On one hand, the photogenerated holes react with adsorbed water molecules and hydroxide anions to produce hydroxyl radicals which are able to degrade various pollutants. Since the oxidative process occurs at or near the surface of the photocatalyst, a high surface area is thus desirable to increase photocatalytic efficiency.

To achieve a large surface area, one main approach is dispersing Mania nanoparticles as suspension into waste effluents (24, 25). However, this approach requires separation and recycling of the TiO₂ fine particles by filtration, which is inconvenient in the practical application of the photocatalytic treatment of wastewater. On the other hand, the photogenerated charge carriers (holes and electrons) have a tendency to recombine with one another. The high degree of recombination between the photogenerated electrons and holes is a major limiting factor controlling photocatalytic efficiency. It has been reported that the recombination between the photogenerated charge carriers can be effectively suppressed by the electrochemical method of applying an external anodic bias (26, 27).

Electrochemistry also offers promising approaches for the elimination of environmental pollution (7, 28, 29). Pollutants can be directly oxidized by hydroxyl radicals and chemisorbed active oxygen species generated by electrochemical anodic oxidation. A variety of anode materials including carbon, Pt, PbO₂, IrO₂, SnO₂, Pt—Ir and boron-doped diamond electrodes have been extensively investigated (2, 30-32). Our recent studies have shown that the, dimensionally stable anode (DSA) Ti/Ta₂O₅—O₂ exhibits excellent electrochemical activity and high stability for the electrochemical remediation of sulfide effluents (33, 34).

Thus it would be very useful to provide a method and system for wastewater remediation and water purification which combines the advantages of photocatalytic decomposition and electrochemical oxidation.

### SUMMARY OF THE INVENTION

The present invention provides a method and system for wastewater remediation and water purification based on the use of bifunctional electrodes involving a marriage of photocatalytic degradation and electrochemical oxidation.

An embodiment of the present invention provides an electrode for combined photocatalytic and electrochemical remediation for removing at least first and second pollutants, said first and second pollutants being any one or combination of organic chemical pollutants, inorganic chemical pollutants and microrganisms, comprising:

a) an electronically conducting substrate having a surface;

b) a photocatalyst applied to a first portion of the surface, the photocatalyst having a bandgap energy (E_{g}); and

c) an electrocatalyst applied to a second portion of the surface;

wherein insertion of said electronically conducting substrate into a liquid containing multiple pollutants, illumination of said photocatalyst with photons of energy equal to or higher than E_{g} and application of an anodic potential bias to said electronically conducting substrate results in said anodic bias potential being applied to said electrocatalyst which induces anodic oxidation of at least a first pollutant at a surface of the electrocatalyst, and a potential drop develops across a thickness of the photocatalyst causing band bending at the surface of the photocatalyst which results in separation of electrons and holes produced in said thickness, which drives holes to the surface and results in anodic oxidation reaction of at least a second pollutant.

The present invention also provides a system for wastewater remediation and water purification for removing at least first and second pollutants, the at least first and second pollutants being any one or combination of organic chemical pollutants, inorganic chemical pollutants and microrganisms, comprising:

a) a bifunctional electrode including
i) an electronically conducting substrate having a surface;
ii) a photocatalyst applied to a first portion of the surface, the photocatalyst having a bandgap energy (E_{g}); and
iii) an electrocatalyst applied to a second portion of the surface;

b) a counter electrode, the bifunctional electrode and counter electrode being connected to a power supply, the power supply being configured to apply an anodic potential bias to said bifunctional electrode; and

c) a light source for emitting photons of energy equal to or higher than E_{g}, said light source being positioned with respect to said bifunctional electrode such that the portion of the surface coated with said photocatalyst is illuminated by said light source;

wherein insertion of said electronically conducting substrate into a liquid containing multiple pollutants, illumination of said photocatalyst with said light source and application of an anodic potential bias to said electronically conducting substrate results in said anodic bias potential being applied to said electrocatalyst, which induces anodic oxidation of at least a first pollutant at a surface of the electrocatalyst, and a potential drop develops across a thickness of the photocatalyst causing band bending at the surface of the photocatalyst, which results in separation of electrons and holes produced in said thickness, which drives holes to the surface and results in anodic oxidation reaction of at least a second pollutant.

In another aspect of the present invention there is provided a method for combined photocatalytic and electrochemical remediation for removing at least first and second pollutants, said first and second pollutants being any one or combination of organic chemical pollutants, inorganic chemical pollutants and microrganisms, the method comprising the steps of:

inserting an electrode into wastewater or contaminated water, the electrode having a surface and having a photocatalyst applied to a first portion of the surface, the photocatalyst having a bandgap energy (E_{g}), and the electrode having an electrocatalyst applied to a second portion of the surface;

illuminating the photocatalyst with photons of energy equal to or higher than E_{g} to produce electron-hole pairs in the photocatalyst; and

applying an anodic potential bias to the electrode resulting in the anodic bias potential being applied to the electrocatalyst which induces anodic oxidation of at least a first pollutant at a surface of the electrocatalyst, and a potential drop developing across a thickness of the photocatalyst causing band bending at the surface of the photocatalyst which results in separation of electrons and holes produced in said thickness, which drives holes to the surface and results in anodic oxidation of at least a second pollutant at a surface of the photocatalyst.

In an embodiment of the invention, the photocatalyst is TiO₂ thin film coated on one side of a conductor; while the electrocatalyst is Ta₂O₅—IrO₂ thin film coated on the opposite side of the conductor. The results of studies disclosed herein clearly show that the application of an anodic potential bias not only greatly enhances the performance of the TiO₂ photocatalyst, but also effectively drives electrochemical oxidation of pollutants at the Ta₂O₅—IrO₂ electrocatalyst.

A further understanding of the functional and advantageous aspects of the invention can be realized by reference to the following detailed description and drawings.

### BRIEF DESCRIPTION OF THE DRAWINGS

The embodiments of the present invention are described with reference to the attached figures, wherein:

FIG. 1(A) shows an embodiment of an electrode for treating flowing wastewater or contaminated water being a cylindrical pipe with the photocatalyst located on the outside surface of the pipe and the electrocatalyst coating on the inner surface so that thepipe is illuminated from the outside;

FIG. 1(B) shows an embodiment of an electrode for treating flowing wastewater or or contaminated water being a cylindrical pipe with the photocatalyst located on the inside surface of the pipe and the electrocatalyst coating on the outer surface so that the pipe is illuminated by a longitudinal lamp extending along the longitudinal axis of the cylinder; and

FIG. 1(C) shows an embodiment of an electrode for treating wastewater or contaminated water which includes a cylindrical pipe with the photocatalyst located on the outside surface of the pipe and the electrocatalyst coating on the inner surface so that the pipe is illuminated from the outside, similar to FIG. 1(A) but including a plurality of holes in the cylinder wall to allow flow of wastewater from the interior to the exterior of the cylinder.

FIG. 2(A) shows an SEM image of a Ta₂O₅—IrO₂ electrocatalyst surface of an exemplary TiO₂/Ti/Ta₂O₅—IrO₂ bifunctional electrode constructed in accordance with the present invention;

FIG. 2(B) shows an SEM image of the TiO₂ photocatalyst surface of the bifunctional electrode of FIG. 2(A);

FIG. 2(C) shows an EDS spectra of the TiO₂ surface and Ta₂O₅—IrO₂ coating of the fabricated bifunctional electrode;

FIG. 3(A) shows linear sweep voltammetric curves at 20 mV/s in 0.15 mM 4-NPh+0.5M NaOH of the TiO₂/Ti/Ta₂O₅—IrO₂ bifunctional electrode in the presence of (a) and in the absence of (b) UV irradiation (b), the TiO₂/Ti monofunctional electrode with (dashed line) and without UV irradiation;

FIG. 3(B) shows steady state current of the TiO₂/Ti/Ta₂O₅—IrO₂ bifunctional electrode measured at 600 mV in 0.15 mM 4-NPh+0.5M NaOH under UV irradiation (c), and without UV irradiation (d);

FIG. 4(A) shows in-situ UV-Vis spectra acquired in 0.15 mM 4-NPh+0.5M NaOH during the photochemical oxidation on the TiO₂/Ti/Ta₂O₅—IrO₂ bifunctional electrode under UV irradiation only;

FIG. 4(B) shows in-situ UV-Vis spectra acquired in 0.15 mM 4-NPh+0.5M NaOH during the photoelectrochemical oxidation on the TiO₂/Ti monofunctional electrode under UV irradiation and with 600 mV applied electrode potential;

FIG. 4(C) shows in-situ UV-Vis spectra acquired in 0.15 mM 4-NPh+0.5M NaOH during electrochemical oxidation on the TiO₂/Ti/Ta₂O₅—IrO₂ bifunctional electrode at 600 mV applied electrode potential;

FIG. 4(D) shows in-situ UV-Vis spectra acquired in 0.15 mM 4-NPh+0.5M NaOH during photoelectrochemical oxidation on the TiO₂/Ti/Ta₂O₅—IrO₂ bifunctional electrode at 600 mV applied potential and under UV irradiation;

FIG. 5 shows plots of In (C/C₀) vs. time for the degradation of 4-NPh in which the experimental conditions are the same as described in FIGS. 4(A) to 4(D);

FIG. 6(A) shows plots of In(C/C₀) vs. time for the degradation of 2-NPh using the four approaches described in FIG. 4(A) to 4(D);

FIG. 6(B) shows a comparison of the percentage of total amount of 2-NPh degraded over the span of three hours using the as-mentioned four methods;

### DETAILED DESCRIPTION OF THE INVENTION

The systems described herein are directed, in general, to embodiments of methods and systems for wastewater treatment and water purification using bifunctional electrodes configured for combined photocatalytic and electrochemical remediation. Although embodiments of the present invention are disclosed herein, the disclosed embodiments are merely exemplary and it should be understood that the invention relates to many alternative forms, including different shapes and sizes. Furthermore, the Figures are not drawn to scale and some features may be exaggerated or minimized to show details of particular features while related elements may have been eliminated to prevent obscuring of novel aspects.

Therefore, specific structural and functional details disclosed herein are not to be interpreted as limiting but merely as a basis for the claims and as a representative basis for enabling someone skilled in the art to employ the present invention in a variety of manners. For purposes of instruction and not limitation, the illustrated embodiments are all directed to embodiments of methods and systems for wastewater treatment and water purification using bifunctional electrodes configured for combined photocatalytic and electrochemical remediation.

As used herein, the term “about”, when used in conjunction with ranges of dimensions of particles, compositions of mixtures, thicknesses of layers, voltages or other physical properties or characteristics, is meant to cover slight variations that may exist in the upper and lower limits of the ranges of dimensions so as to not exclude embodiments where, on average, most of the dimensions are satisfied but where statistically dimensions may exist outside this region. It is not the intention to exclude embodiments such as these from the present invention.

The present invention provides a method and system for wastewater treatment and water purification using bifunctional electrodes configured for combined photocatalytic and electrochemical remediation. The present method is predicated on the surprising result that, by applying an anodic potential bias to a bifunctional electrode containing on one surface thereof a semiconductor based photocatalyst (which upon illumination absorbs photons to produce electron-hole pairs) and on the other surface of the electrode an electrocatalyst, not only is the performance of the photocatalyst improved due the application of the potential across the photocatalyst, but also the applied potential bias effectively drives electrochemical oxidation of pollutants at the electrocatalyst, and can produce products which can migrate to the electrocatalyst to scavenge one of the photogenerated electrons (or holes) thereby further reducing the recombination of photogenerated charge carriers leaving more of the photogenerated holes (or electrons). This surprising synergy forms a basis of the present invention.

With the electrocatalyst and photocatalyst under anodic bias both the electrocatalyst and photocatalyst serve as the anode thereby providing for waste chemical removal and water disinfection while hydrogen production occurs on the cathode. This hydrogen may be captured and stored for commercial usage when the present method is utilized in large scale waste treatment plants. A preferred substrate is titanium metal, film, sheet or plate, which has been shown to have high conductivity and low cost. Titanium is also very durable towards corrosion, regardless of the liquid composition, which is important in view of the exposure of the electrode to potentially corrosive, harsh environments. Other substrates which may be used include, but are not limited to, stainless steel, niobium, tantalum, and carbon. Flexible, conducting substrates may be used which may or may not be polymer based substrates. The supporting electrode onto which the photocatalyst and electrocatalyst are applied may be made of any metal or conductor as long as they can withstand the environment in which they need to operate. Thus, the substrate may be any one of metal sheets, metal plates, metal mesh, conducting polymers, and any combination thereof.

It is noted that while illustrated with one photocatalyst and one electrocatalyst, the present invention is not in any way limited to just one of each. Depending on the application at hand, the number of pollutants one may wish to remove, two or more different types of electrocatalyst and/or two or more different types of electrocatalyst may be used. In addition to being able to tune the configuration of electrocatalyst/photocatalyst by varying the relative surface area of each on the substrate, one can use simultaneously two or more different types of electrocatalyst and/or two or more different types of electrocatalyst depending on the kinetics and energetic requirements of the system.

Many different electrocatalysts may be used with different combinations of photocatalysts. Application of an anodic bias to the bifunctional electrode results in the electrochemically oxidizing the pollutant species and generating oxygen. Ta₂O₅—IrO₂ is a preferred electrocatalyst because this catalyst has shown high electrocatalytic activity and stability. Other possible electrocatalysts include, but are not limited to, SnO₂, RuO₂, IrO₂, PbO₂, Pt, Sb₂O₅—SnO₂, doped SnO₂—Sb₂O₅, and carbon, to mention a few.

A wide variety of photocatalysts such as metal oxides TiO₂, Fe₂O₃, ZnO, SnO₂, in addition to silicon, can be used as well. Thus, TiO₂ is just an example of the photocatalyst that may be used. In addition, TiO₂ doped with other elements such as carbon, nitrogen, fluorine, boron, platinum and/or gold may be used to further improve the activity of a TiO₂-based photocatalyst and enhance its response to visible light. Thus the present invention is not limited to pure TiO₂.

The method disclosed herein is not restricted to any particular pollutants, and in fact it can work on any combination of organic pollutants. Further, inorganic pollutants, as well as bacteria and other microorganisms, may also be degraded using the present combined method of photochemical degradation and electrochemical oxidation. The present method may also be used for water purification (e.g., groundwater, tap water) to be drinkable.

Various embodiments of the present invention will now be discussed. The present invention relies upon the use of a bifunctional electrode having on one side a photocatalyst and on the other side an electrocatalyst. The photocatalyst is essentially a photoconductor or semiconductor which, upon absorption of light of energy higher than the bandgap energy, produces electron-hole pairs. When immersed in an electrolyte, without being illuminated, electronic equilibrium is established between the solid and liquid phases. This equilibrium is obtained by the flow of carriers across the interface between the photocatalyst and liquid until the electrochemical potential of the photoconductor majority carriers is equal throughout the entire semiconductor-electrolyte system. This flow of charge results in band bending at the surface and this region of band bending is called the space charge region.

A typical photocatalyst without a potential bias applied across it has a high recombination rate due to the fact this space charge region does not have a high enough driving force present to efficiently separate the electron-hole pairs. Some charges will be present at the surface of the photoconductor which can photoreact with chemical species in solution located at the interface, but generally the reaction rates are low due to this high recombination rate. In the present invention, the application of a bias potential to the substrate results in band bending of the conduction and valence bands down into the depths of the photoconductor, which then serves to more efficiently separate the electron-hole pairs. Under anodic bias, potential applied to the photoconductor results in much steeper band bending, forcing holes in the valence band to the surface and electrons into the bulk of the photocatalyst.

There are several considerations that go into the selection of the photocatalyst or semiconductor to be deposited onto the substrate. The Example below uses TiO₂ which is a well known semiconductor photocatalyst, but the present invention is not restricted to TiO₂ as the photocatalyst. As mentioned above, metal oxides including, but not limited to, ZnO, SnO₂, silicon and other photocatalysts may be used, to give a few examples. However, TiO₂ is a preferred photocatalyst for this application due to its low cost and high performance.

In addition, other useful substrates onto which the photocatalyst and electrocatalyst may be deposited include, but are not limited to, stainless steel, carbon based electrodes, niobium, indium tin oxide (ITO), and tin oxide (SnO₂), to mention just a few.

Further, while the above example had one surface of the substrate coated with the photocatalyst and the electrocatalyst applied on the other side of the substrate, it will be understood that the photocatalyst and electrocatalyst may be applied on the same side of the substrate, i.e. they do not need to be on opposite sides of the substrate. For example, the photocatalyst may be located in one or more sections on one side of the substrate and the electrocatalyst may be applied to other sections. For a given substrate area, half of it may be coated with the photocatalyst while the other half may be coated with the electrocatalyst. Depending on the particular chemicals being removed from the wastewater, the photocatalyst and the electrocatalyst, and depending on the relative reaction kinetics of the photocatalytic reaction and the electrocatalytic reaction, it may be preferable to scale the surfaces of the photocatalyst and the electrocatalyst sections in proportion to their reaction kinetics.

Another approach is to fabricate two separate photocatalyst and electrocatalyst substrates and then connect them together electrically. Any combination of photocatalyst and electrocatalyst may be used; the novelty of this technology is combining both photochemical degradation and electrochemical oxidation.

The electrode may be coated with a ratio of the surface area of the photocatalyst on a first portion to a surface area of the electrocatalyst on the second portion being selected to give a pre-selected reaction ratio of the anodic oxidation of a first pollutant at the surface of the electrocatalyst to the anodic oxidation reaction of a second pollutant at the surface of the photocatalyst.

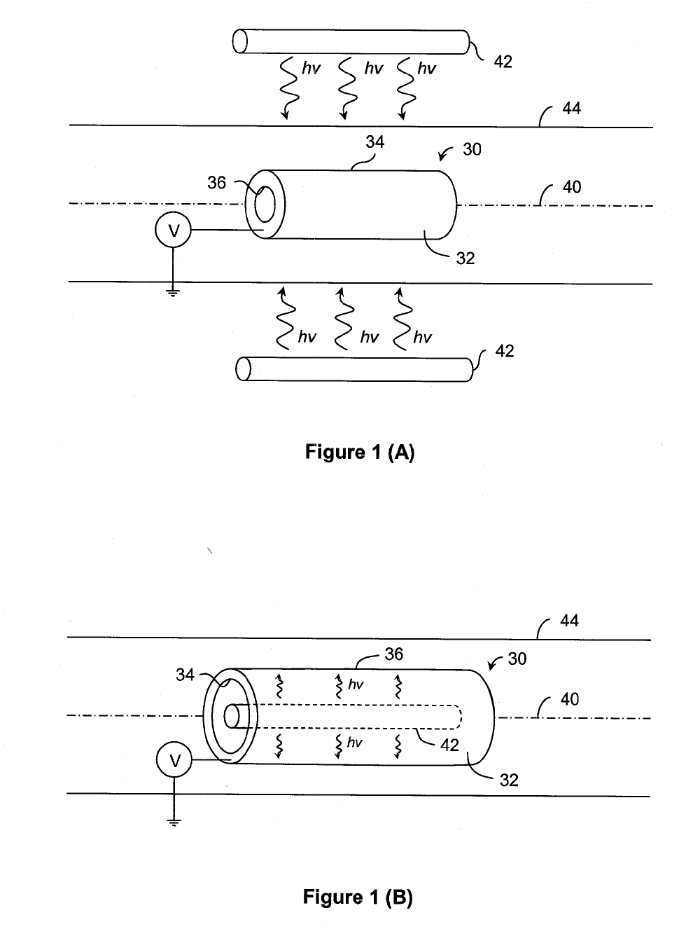

For practical implementation of the present invention for treatment of wastewater, several embodiments of the bifunctional electrodes may be constructed. FIG. 1(A) shows an embodiment of an electrode 30 for treating flowing wastewater, being a generally cylindrically shaped pipe 32 (which covers pipes of other cross sections including square, rectangular etc.) with the photocatalyst layer 34 located on the outside surface of the pipe 32 and the electrocatalyst layer 36 located on the inner surface of the pipe 32. The pipe 32 is illuminated from the outside using lamps emitting at the appropriate wavelengths equal to and above the bandgap energy of the photocatalyst such that the photocatalyst absorbs the light and produces electron-hole pairs. The pipe 32 (or multiple pipes 32) are immersed in the flowing wastewater so that the axis 40 of the pipe is parallel to the flow path of the wastewater. Lamps 42 may be placed in flow tanks 44 in which the pipes 32 are located, or tanks 44 may be made of clear plastic and the lamps 42 located on the outside of tanks 44, the plastic being selected so that it does not absorb heavily in the spectral range above the bandgap of the photocatalyst.

FIG. 1(B) shows another embodiment of an electrode 50 for treating flowing wastewater, being a cylindrical pipe 32 with the photocatalyst layer 34 located on the inner surface of the pipe 32 and the electrocatalyst layer 36 located on the outer surface of the pipe 32 (which is reversed from the configuration of FIG. 1(A)). The pipe 32 is illuminated from the inside using lamps aligned along the longitudinal axis 40 of the pipe 32 which emit at the appropriate wavelengths equal to and above the bandgap energy of the photocatalyst layer 34 such that the photocatalyst absorbs the light and produces electron-hole pairs. The pipe 32 (or multiple pipes 32) are immersed in the flowing wastewater so that the axis 40 of the pipe is parallel to the flow path of the wastewater.

FIG. 1(C) shows an embodiment of an electrode for treating wastewater which includes a cylindrical pipe 50 with the photocatalyst layer 34 located on the outside surface of the pipe 50 and the electrocatalyst layer 36 located on the inner surface so that the pipe is illuminated from the outside, similar to FIG. 1(A). Pipe 50 includes a plurality of holes 52 in the pipe wall to allow flow of wastewater from the interior to the exterior of the pipe 50. Pipe 50 may be used for batch treatment of non-flowing wastewater such that the holes allow mixing and escape of the reaction products from the interior of pipe 50. For treatment of large batches, large arrays of multiple pipes 50 may be inserted into the tanks 44. The presence of holes 52 along the pipe 50 will allow for the passage of the electrochemically generated oxygen from the electrochemical electrode surface to the photochemical electrode face, which can capture the photo-generated electrons.

In all these embodiments the cylindrically shaped pipes may optionally be plastic pipes having an electrically conductive coating deposited onto both the outer and inner surface thereof, onto which the electrocatalyst is coated and the photocatalyst is deposited. The power supply is electrically connected to this electrically conductive coating for applying the anodic bias potential simultaneously to both the electrocatalyst and the photocatalyst.

It will be appreciated by those skilled in the art that the configurations shown in FIGS. 1A, 1B and 1C are not meant to be limiting in any way but rather are a few example embodiments of a treatment system employing the bifunctional electrode disclosed herein.

The invention will now be illustrated using the following non-limiting example of a bifunctional catalyst based on titanium in which a titanium (Ti) plate is used as the substrate in fabricating the bifunctional electrodes because of its high corrosion-resistance and relatively low cost. The photocatalyst (TiO₂ thin film) was coated on one side of the Ti plate while the electrocatalyst (Ta₂O₅—IrO₂ thin film) was coated on the opposite side to give the bifunctional electrode. To illustrate the utility of the application and not limit it in anyway, 4-nitrophenol (4-NPh) and 2-nitrophenol (2-NPh) were chosen as model pollutants and tested in this study. Nitrophenols are among the most common toxic persistent pollutants in industrial and agricultural wastewater. They are considered to be hazardous waste and priority toxic pollutants by the U.S. Environmental Protection Agency (35). Generally speaking, purification of wastewater polluted with 4-NPh or 2-NPh is very difficult as the presence of a nitro group in the aromatic ring enhances the stability of the nitrophenolic compounds in chemical and biological degradation (36).

### EXAMPLE

### Experimental Section Materials.

2-NPh, 4-NPh (Aldrich) and sodium hydroxide (Anachemia) were used as received. Pure water (18 MΩcm) was obtained from a Nanopure Diamond® water purification system. Ti(OBu)₄, IrCl₃.3H₂O (Pressure Chemical Corp.) and TaCl₅ (Aldrich) were used to prepare precursor solutions for the synthesis of the photocatalyst and electrocatalyst.

### Electrode Preparation and Characterization.

The TiO₂/Ti/Ta₂O₅—IrO₂ bifunctional electrodes were prepared using thermal decomposition technique. Pure titanium plates of 1.0×12.5×8 mm were first degreased by sonication in acetone for 10 min, then washed with pure water, etched in 18% HCl at 85° C. for 15 min, then completely washed with pure water and finally dried in a vacuum oven at 40° C. The TiO₂ precursor solution was prepared by adding 1.56 ml of Ti(OBu)₄ to 13.41 ml of butanol. The Ta₂O₅—IrO₂ precursor solution was made by mixing the iridium precursor solution (dissolving 0.30 g of IrCl₃.3H₂O in 2.5 ml of ethanol) and the tantalum precursor solution (0.13 g TaCl₅ dissolved in 7.5 ml of isopropanol).

To prepare the TiO₂/Ti/Ta₂O₅—IrO₂ bifunctional electrodes, the TiO₂ precursor solution was painted onto one side of the etched Ti substrates and the Ta₂O₅—IrO₂ precursor solution was painted onto the opposite face of the pre-treated Ti substrates. The solvents were evaporated in an air stream at 80° C. The electrode samples were calcinated at 450° C. for 10 min between each coating. This process was repeated to place six coats of the TiO₂ precursor onto one side and six coats of the Ta₂O₅—IrO₂ precursor onto the other side of the Ti substrates, followed by a final calcination at 450° C. for 1 h. For comparison, mono-functional TiO₂/Ti electrodes with six coats of the TiO₂ photocatalyst but without the Ta₂O₅—IrO₂ electrocatalyst were also prepared using the thermal decomposition technique. The prepared electrodes were characterized by scanning electron microscopy (SEM) (JEOL JSM 5900LV) equipped with an energy dispersive x-ray spectrometer (EDS) (Oxford Links ISIS).

### Activity Studies.

Electrochemical and photoelectrochemical experiments were carried out in a three electrode cell system controlled by a Voltalab 40 potentiostat (PGZ 301, Radiometer Analytical). A Pt coil was used as the counter electrode and flame annealed before the experiments. A saturated Ag/AgCl electrode was employed as the reference electrode. The UV source was CureSpot 50 (ADAC systems) equipped with an Hg lamp. The wavelength range was from 300 nm to 450 nm; the measured light irradiance was around 2.0 mW/cm2. The light from the source was guided through a fiber and projected on the surface of the fabricated TiO₂ photocatalyst. A 0.5 M NaOH solution served as the supporting electrolyte. The initial concentration of 4-NPh and 2-NPh was 0.15 mM. In-situ UV-Vis spectroscopy (Stellar-Net EPP 2000) was used to monitor the concentration of 4-NPh and 2-NPh during their photochemical, electrochemical and photoelectrochemical degradation. The nitrophenolic solutions were constantly stirred during the degradation processes. All the activity tests were performed at room temperature (20±2° C.).

### Results and Discussion

### Characterization of the Prepared TiO₂/Ti/Ta₂O₅—IrO₂ Electrodes.

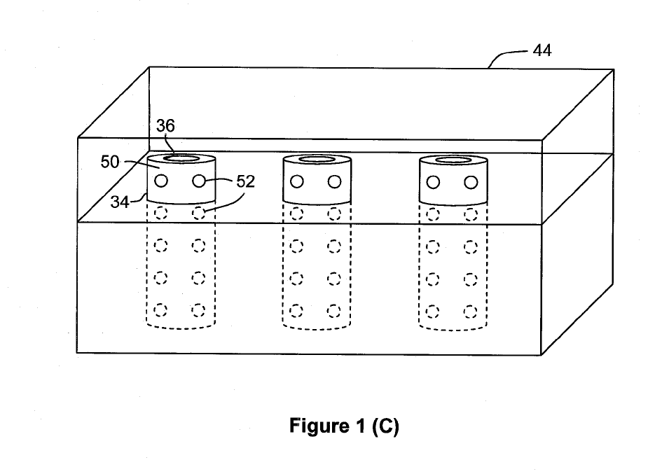

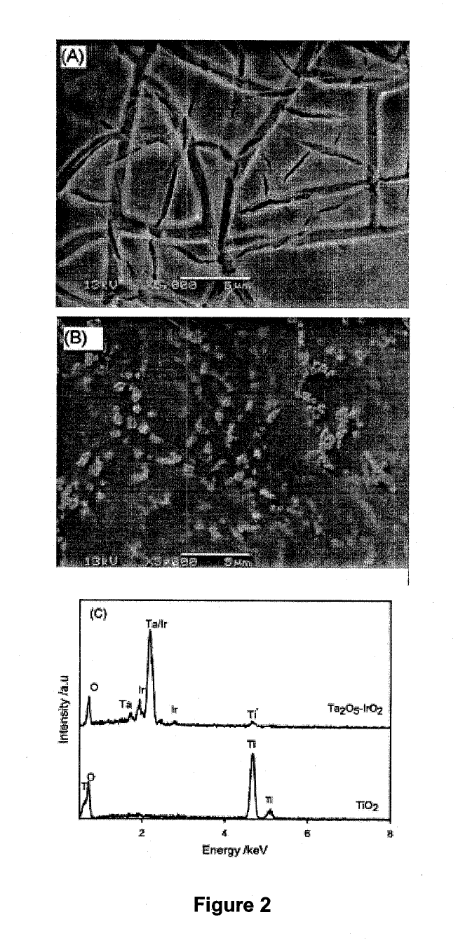

SEM was employed to characterize the surface morphology and structure of the synthesized oxide coatings. As seen in FIG. 2A, the Ta₂O₅—IrO₂ coating prepared with the thermal decomposition method displays a typical “cracked-mud” structure. FIG. 2B shows the SEM image of the TiO₂ coating. Along with the cracked-mud structure, some small “islands” are presented on the TiO₂ surface. FIG. 2C presents the EDS spectra of the bifunctional electrodes, confirming that the Ta₂O₅—IrO₂ coating was formed on one side of the Ti substrate and the TiO₂ coating was formed on the opposite side. In the EDS spectrum of the Ta₂O₅—IrO₂ coating, the small peak, labeled Ti*, is derived from the Ti substrate. Quantitative analysis of the EDS spectrum reveals that the molar ratio of Ta₂O₅ to IrO₂ is 0.3:0.7 in the Ta₂O₅—IrO₂ coating, which is consistent with the composition of the Ta₂O₅—IrO₂ precursor solution.

### Photocurrent and Electrochemical Current Responses.

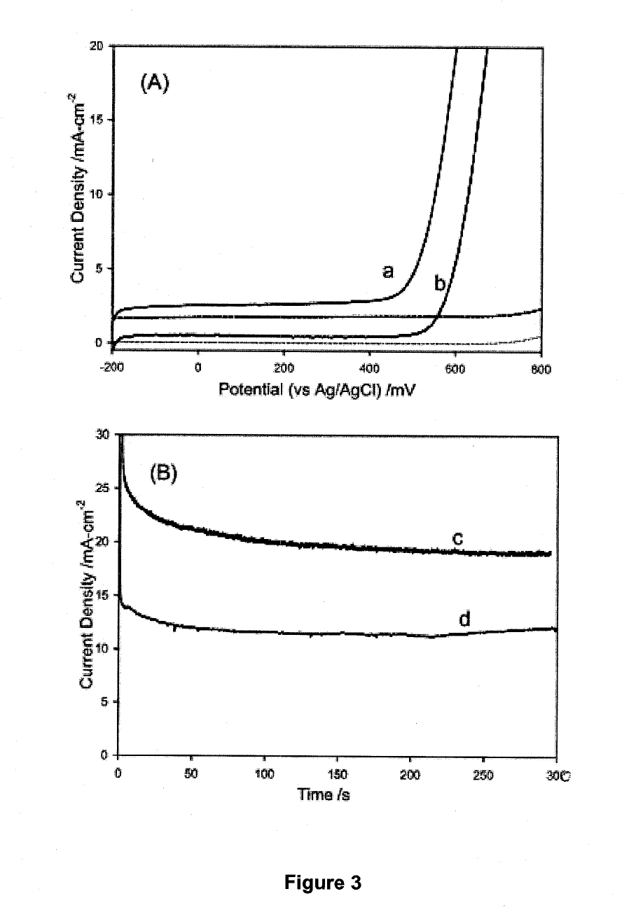

To compare the induced photocurrent and electrochemical current of the bifunctional electrodes, linear voltammetric (LV) experiments at a potential scan rate of 20 mV/s in 0.15 mM 4-NPh+0.5M NaOH were performed on the TiO₂/Ti/Ta₂O₅—IrO₂ bifunctional electrode and the TiO₂/Ti monofunctional electrode. The LV plots are presented in FIG. 3A.

For the TiO₂/Ti monofunctional electrode, as expected, the very small, but constant, current (dotted line) resulted from charging the electrical double layer when scanning the potential from −200 mV to 800 mV, as TiO₂ is a poor electrocatalyst; upon UV irradiation, ˜2.2 mA photocurrent was created (dashed line). For the TiO₂/Ti/Ta₂O₅—IrO₂ bifunctional electrode, in the absence of UV irradiation on the TiO₂ coating, the onset potential of oxygen evolution on the Ta₂O₅—IrO₂ coating was around 500 mV as shown in Curve b. The current is almost constant at potentials lower than 500 mV due to charging the electrical double layer. Further scanning the potential from 500 to 800 mV, the electrochemical current underwent a rapid linear increase due to oxygen evolution. Curve a is the LV plot of the TiO₂/Ti/Ta₂O₅—IrO₂ electrode in the presence of the UV irradiation on the TiO₂ coating. Comparison of Curve a and b shows that: (i) the onset potential of the electrochemical oxygen evolution shifted from ˜500 mV to ˜450 mV upon UV irradiation; (ii) the photocurrent created by the UV irradiation at potentials lower than 450 mV is ˜2.5 mA, arrived at by subtracting the double layer charging current (Curve b) from the total current (Curve a); and (iii) the UV irradiation created a much larger current when the applied potential bias was higher than 450 mV. For instance, at 600 mV, the total current including the electrochemical current and the photocurrent of the TiO₂/Ti/Ta₂O₅—IrO₂ (Curve b) is 20.22 mA. This was much higher than the electrochemical current of the Ta₂O₅—IrO₂ coating (Curve a), 5.63 mA.

Further studies were conducted to measure the steady-state currents using the chronoamperometric (CA) method as shown in FIG. 3B. The CA experiments were performed under the applied potential of 600 mV, with UV radiation (Curve c) and without UV irradiation (Curve d). Under the applied 600 mV bias electrode potential, the electrochemical current of the Ta₂O₅—IrO₂/Ti/TiO₂ electrode without UV irradiation holds near steady at approximately 13 mA (Curve d); in contrast, upon the UV irradiation, the steady-state current reaches a level of over 20 mA (Curve c), showing a significant synergetic effect of UV irradiation and the applied electrode potential on the induced current of the bifunctional electrode. Thus, the electrode potential 600 mV was chosen for the degradation of 4-NPh and 2-NPh pollutants.

### Degradation of 4-NPh.

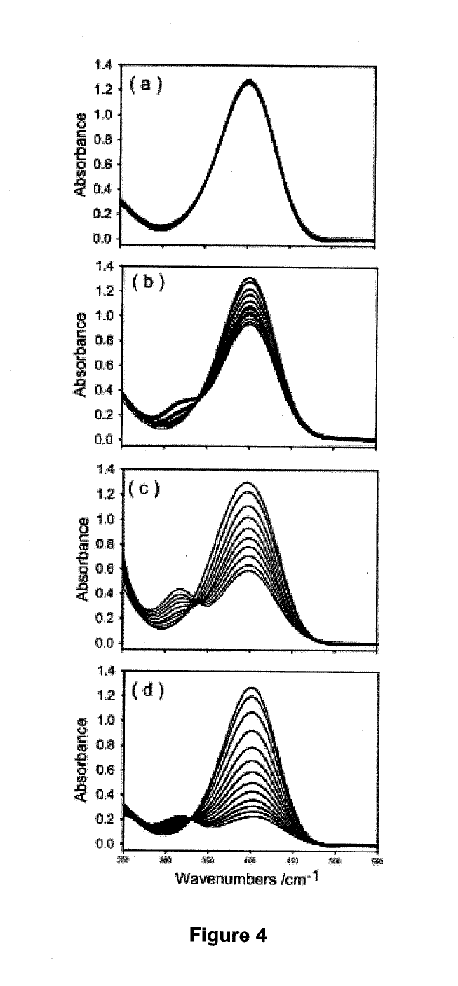

The performance of the fabricated bifunctional electrodes was first tested using 4-NPh as a model pollutant. UV-Vis spectroscopy was employed to monitor in situ the absorbance change of 4-NPh during the degradation experiments. FIGS. 4a to 4d presents the scanning kinetics graphs taken at 15-minute intervals during the degradation of 4-NPh on the TiO₂/Ti/Ta₂O₅—IrO₂ bifunctional electrode (FIGS. 4a, 4c and 4d) and on the TiO₂/Ti monofunctional electrode (FIG. 4b). 4-NPh has a main absorption band centered at 400 nm which reflects the concentration of 4-NPh in the solution. The decrease of the intensity of this peak over time is confirmation of the degradation of 4-NPh.

As shown in FIG. 4a, the main absorption band of 4-NPh only slightly decreased (less than 7%) during three-hour photochemical degradation on the TiO₂/Ti/Ta₂O₅ bifunctional electrode under UV irradiation without applying any external anodic potential bias, indicating a high rate of recombination of the photogenerated electrons and holes. The benefit from application of a potential bias to a photocatalyst is illustrated in FIG. 4b, where the TiO₂/Ti monofunctional electrode was held at 600 mV with UV irradiation. The main, absorption band of 4-NPh decreased by ˜30% over the three-hour degradation period. Comparison of FIGS. 4a and 4b reveals that the applied anodic potential bias slows the recombination of the photogenerated electrons and holes and greatly enhances the efficiency of the photochemical degradation.

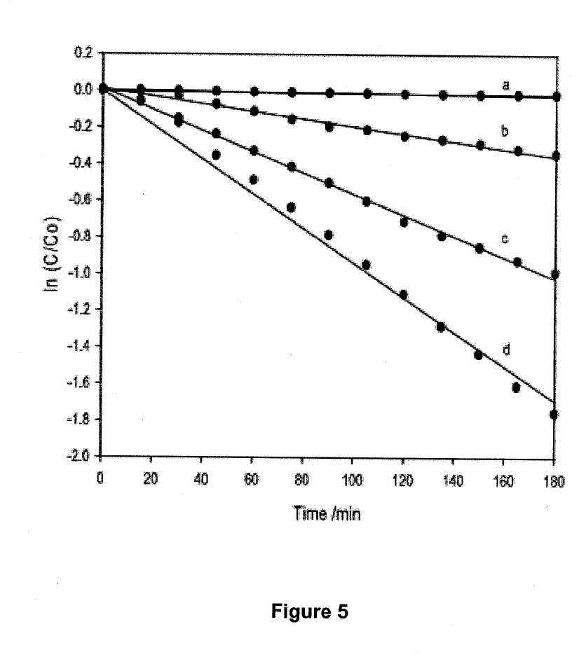

The performance of the Ta₂O₅—IrO₂ electrocatalyst of the bifunctional electrode is shown in FIG. 4c, where an anodic potential bias of 600 mV was applied to the TiO₂/Ti/Ta₂O₅—IrO₂ electrode without any UV irradiation on the TiO₂ photocatalyst. Approximate 55% of the 4-NPh was degraded through the three-hour electrochemical oxidation. The novel technique of combining photochemical degradation and electrochemical oxidation was tested by irradiating the bifunctional TiO₂/Ti/Ta₂O₅—IrO₂ electrode with UV light and applying a potential of 600 mV as shown in FIG. 4d. As can be seen, over 85% of 4-NPh was degraded during the three hour photo-electrochemical oxidation. As shown in FIGS. 4a to 4c, the UV-Visible absorption of 4-NPh decreased with time, during the degradation experiments. Using a calibration curve, the absorbance value of the 400 nm peak can be related back to the concentration of the 4-NPh. FIG. 5 presents the corresponding ln(c/co) vs. time plots for the tests reported in FIGS. 4a to 4c. The linear relationship of ln(c/co) vs time shows that the degradation of 4-NPh using either the monofunctional or bifunctional electrodes follows pseudo-first order kinetics:

ln c/c₀=−kt (¹)

where c/c₀ is the normalized 4-NPh concentration, t is the reaction time, and k is the reaction rate constant in term of min⁻¹. The TiO₂/Ti/Ta₂O₅—IrO₂ electrode under UV irradiation but without any external anodic potential bias has the lowest photochemical degradation rate constant, 1.11×10⁻⁴ min⁻¹ (FIG. 5a), caused by a high degree of recombination between the photogenerated electrons and holes. As shown in FIG. 5b, the photoelectrochemical degradation rate constant of 4-NPh on the TiO₂/Ti electrode at the applied electrode potentil 600 mV and with UV irradiation was 2.03×10⁻³ min⁻¹. This is much larger than the slope of FIG. 5a, demonstrating that the applied potential bias effectively suppresses recombination between the photogenerated electrons and holes.

As shown in FIG. 5c, the electrochemical oxidation of 4-NPh on the bifunctional electrode at the applied electrode potential 600 mV but without UV irradiation gave a rate constant of 5.74×10⁻³ min⁻¹. Among the four plots, FIG. 5d, for the TiO₂/Ti/Ta₂O₅—IrO₂ bifunctional electrode at the applied electrode potential 600 mV and upon UV irradiation, had the highest slope, 1.06×10⁻² which is 100 times larger than the rate constant shown in FIG. 5a. The above results demonstrate the huge benefits of the marriage of photocatalytic degradation and electrochemical oxidation for the environmental remediation of organic pollutants.

### Degradation of 2-NPh.

To further test the strength of this novel method, a second model pollutant, 2-NPh, was used in the degradation studies. The initial concentration of 0.15 mM 2-NPh in 0.5 M NaOH was used, and in situ UV-visible spectra of 2-NPh were taken every 15 minutes for 90 minutes using the four degradation approaches which were employed for the degradation of 4-NPh as described above. The main absorption band of 2-NPh is centered at 412 nm, which was used in this study to monitor the concentration change of 2-NPh during the four different degradation approaches.

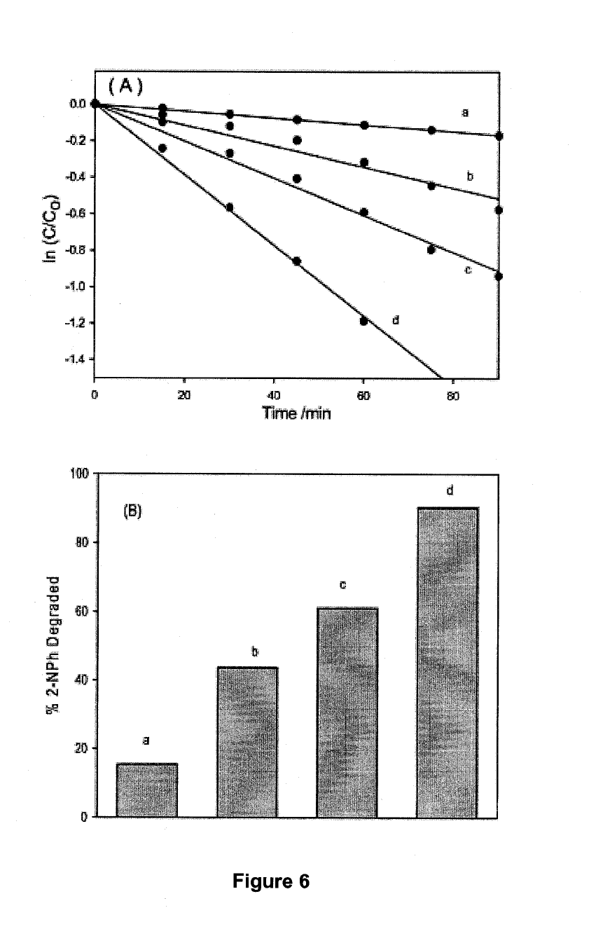

FIG. 6A presents the ln(C/Co) vs. t plots for the degradation of 2-NPh on: (a) the TiO₂/Ti/Ta₂O₅—IrO₂ bifunctional electrode under the UV irradiation but without any applied anodic potential bias; (b) the TiO₂/Ti monofunctional electrode at the applied electrode potential 600 mV and under UV irradiation; (c) the TiO₂/Ti/Ta₂O₅—IrO₂ bifunctional electrode at the applied electrode potential 600 mV but without UV irradiation; and (d) the TiO₂/Ti/Ta₂O₅—IrO₂ bifunctional electrode at the applied electrode potential 600 mV and under UV irradiation. The linear relationship of the ln(C/Co) vs. t plots shows that the kinetics of the degradation of 2-NPh is pseudo-first order.

Combination of the photochemical and electrochemical oxidation (Plot d) created the highest degradation rate with a value of 1.93×10⁻² min⁻¹, which was 10 times higher than the degradation rate (1.86×10⁻³ min⁻¹) produced by only the photochemical oxidation (Plot a), and was over triple the rate (5.27×10⁻³ min⁻¹) given by the photoelectrochemical degradation on the TiO₂/Ti monofunctional electrode (Plot b). As shown in Plot c, the electrochemical oxidation of 2-NPh on the bifunctional electrode produced a rate constant of 9.88×10⁻³ min⁻¹. Comparison of the degradation rates of 4-NPh and 2-NPh on the TiO₂/Ti/Ta₂O₅—IrO₂ bifunctional electrode is presented in Table 1, showing that (i) 2-NPh is more easily removed than 4-NPh; and (ii) the combination of the photochernical and electrochemical oxidation exhibits the highest degradation rates. FIG. 6B illustrates the total amount of 2-NPh eliminated over the three hour degradation. For the TiO₂/Ti/Ta₂O₅—IrO₂ bifunctional electrode, 16% of 2-NPh was degraded under UV irradiation only (a); 61% of 2-NPh was removed when 600 mV potential was applied (c); combination of the photochemical and electrochemical oxidation eliminated over 90% of 2-NPh (d). In contrast, for the TiO₂/Ti monofunctional electrode, under the same experimental conditions as (d), ˜40% of the 2-NPh was degraded.

TABLE 1
Comparison of the degradation rate constants of 4-NPh and 2-NPh derived
from FIGS. 4 and FIG. 5A on the TiO₂/Ti/Ta₂O₅—IrO₂ bifunctional
electrode.

| Experiments | Photochemical | Electrochemical | Photoelectrochemical |
|---|---|---|---|
| 4-NPh | 1.11 × 10⁻⁴ | 5.74 × 10⁻³ | 1.06 × 10⁻² |
| (min⁻¹) | | | |
| 2-NPh | 1.86 × 10⁻³ | 9.88 × 10⁻³ | 1.93 × 10⁻² |
| (min⁻¹) | | | |

The Example disclosed above demonstrates that the non-limiting example of the prepared TiO₂/Ti/Ta₂O₅—IrO₂ bifunctional electrode exhibits superb activity for 4-NPh and 2-NPh degradation.

In summary, the present invention provides a novel and facile approach for wastewater treatment and water purification based on the use of bifunctional electrodes with the presence of electrocatalysts. This innovative approach has at least four major advantages: (i) as the photocatalysts are coated on the Ti substrate, the tedious procedure for separation and recycling of the TiO₂ suspension in the waste effluents is avoided; (ii) an anodic potential bias can be easily applied to the bifunctional electrode, thus effectively suppressing the recombination of photogenerated electrons and holes on the photocatalyst face; (iii) full use of the extra applied energy is provided, as it also drives the electrochemical oxidation on the electrocatalyst; and (iv) the anodic potential bias applied to the bifunctional electrode promotes hydroxyl radical formation and oxygen evolution at the electrocatalyst face. This oxygen moves to the surface of the TiO₂ catalyst and scavenges the conduction band electrons to form superoxide ions (O₂*—) (1), further decreasing the recombination of the photogenerated charge carriers. The produced superoxide ion also acts as an oxidant to mineralize organic pollutants. The prepared TiO₂/Ti/Ta₂O₅—IrO₂ bifunctional electrode exhibits superb activity for 4-NPh and 2-NPh degradation and the approach described in this study provides a very promising environmental technology for water purification and waste effluent treatment.

In the above Example the TiO₂/Ti/Ta₂O₅—IrO₂ bifunctional electrode was made using titanium sheet onto which the photocatalyst TiO₂ was deposited on one side and the electrocatalyst Ta₂O₅—IrO₂ deposited onto the opposite surface. It will be appreciated by those skilled in the art that instead of using titanium as the substrate, tantalum may be used with the Ta₂O₅—IrO₂ being produced on one side and TiO₂ being deposited on the other side.

As used herein, the terms “comprises” and “comprising” are to be construed as being inclusive and open ended, and not exclusive. Specifically, when used in this specification including claims, the terms, “comprises” and “comprising” and variations thereof mean the specified features, steps or components are included. These terms are not to be interpreted to exclude the presence of other features, steps or components.

The foregoing description of the preferred embodiments of the invention has been presented to illustrate the principles of the invention and not to limit the invention to the particular embodiments illustrated. It is intended that the scope of the invention be defined by all of the embodiments encompassed within the following claims and their equivalents.

### Literature Cited

(1) Augugliaro, V.; Litter, M.; Palmisano, L.; Soria, J. The combination of heterogenous photocatalysis with chemical and physical operations. J. Photochem. Photobiol. C:Photochem Rev. 2006, 7, 127-144.

(2) Martinez-Huitle, C. A.; Ferro, S. Electrochemical oxidation of organic pollutants for wastewater treatment: direct and indirect process. Chem. Soc. Rev. 2006, 35, 1324-1340.

(3) Xu, C.; Killmeyer, R.; Gray, M. L.; Khan, S. U. M. Enhanced carbon doping of TiO2 thin films for photoelectrochemical water splitting. Electrochem. Commun. 2006, 8, 1650-1654.

(4) Bunce, N. J.; Merica, S. G.; Lipkowski, J. Prospects for the use of electrochemical methods for the destruction of aromatic organochlorine wastes. Chemosphere 1997, 35, 2719-2726.

(5) Ezerskis, Z.; Jusys, Z. Electropolymerization of chlorinated phenols on a Pt electrode in alkaline solution. J. App. Electrochem. 2002, 32, 543-550.

(6) Zhu, X.; Shi, S.; Wei, J.; Lu, F.; Zhao, H.; Kong, J.; He, Q.; Ni, J. Electrochemical oxidation characteristics of p-substituted phenols using a Boron-doped diamond electrode. Environ. Sci. Technol. 2007, 41, 6541-6546.

(7) Tian, M.; Bakovic, L.; Chen, A. Kinetics of the electrochemical oxidation of 2-nitrophenol and 4-nitrophenol studied by in situ UV spectroscopy and chemometrics, Electrochim. Acta, 2007, 52, 6517-6524.

(8) Raju, T.; Chung, S. J.; Pillai, K. C.; Moon, I. S. Simultaneous removal of NOx and SO2: A promising Ag(II)/Ag(II) based mediated electrochemical oxidation system. Clean-Soil. Air Wat. 2008, 36, 476-481.

(9) Martinez-Huitle, C. A.; De Battisti, A.; Ferro, S.; Reyna, S.; Cerro-Lopez; M.; Quiro, M. A. Removal of the pesticide methamidophos from aqueous solutions by electrooxidation using Pb/PbO2, Ti/SnO2, Si/BDD electrodes. Environ. Sci. Technol. 2008, 42, 6929-6935.

(10) Chai, X. L.; Zhao, Y. C. Adsorption of phenolic compounds by aged-refuse. J. Hazard. Mat. 2006, 137, 410-417.

(11) Pena, M.; Meng, X.; Korfiatis, G. P.; Jing, C. Adsorption mechanism of arsenic on nanocrystalline titanium dioxide. Environ. Sci. Technol. 2006, 40, 1257-1262.

(12) Christensen, P. A.; Egerton, T. A.; Kosa, S. A. M.; Tinlin, J. R.; Scott, K. Photochemical oxidation of aqueous nitrophenols using a novel reactor. J. App. Electrochem. 2006, 35, 683-692.

(13) Malpass, G. R. P.; Miwa, D. W.; Miwa, A. C. P.; Machado, A. S.; Motheo, A. J. Photo-assisted electrochemical oxidation of atrazine on a commericial Ti/Ru0.3Ti0.7O2 DSA electrode. Environ. Sci. Technol 2007, 41, 7120-7125.

(14) Peng, X.; Chen, A. Large-scale synthesis and characterization of TiO2-based nanostructures on titanium substrate. Adv. Fund. Mater. 2006, 16, 1355-1362.

(15) Ye, X. J.; Chen, D.; Li, K. Y.; Shah, V. Photocatalytic oxidation of aldehydes/PCE using porous anatase titania and visible-light-responsive brookite titania. Chem. Eng. Commun.2007, 194, 368-381.

(16) Liu, Z. Y.; Zhang, X. T.; Nishimoto, S.; Mruakami, T.; Fujishima, A. Efficient photocatalytic degradation of gaseous acetaldehyde by highly ordered TiO2 nanotube arrays. Environ. Sci. Technol. 2008, 42, 8547-8551.

(17) Fujishima, A.; Rao, T. N.; Tryk, D. Titanium dioxide photocatalysis. J. Photochem. Photobio. C: Photochem. Rev. 2000, 1, 1-21.

(18) Amano F.; Yamaguchi T.; Tanaka T. Photocatalytic oxidation of propylene with molecular oxygen over highly dispersed titanium, vanadium and chromium oxides on silica. J. Phys. Chem. B 2006, 110, 281-288.

(19) Xu, T.; Cai, Y.; O'Shea, K. E. Adsorption and photocatalyzed oxidation of methylated arsenic species in TiO2 suspensions. Environ. Sci. Technol 2007, 41, 5471-5477.

(20) Chen, A.; Peng, X.; Holt-Hindle, P. TiO2 Nanostructured Materials: Design, Characterization and Applications. In Frontal Nanotechnology Research; M. V. Berg, M. V., Ed.; Nova Science Publishers, Inc., 2007; pp 131-159.

(21) Ryu, J.; Choi, W. Photocatalytic oxidation of arsenite on TiO2: understanding the controversial oxidation mechanism involving superoxides and the effect of alternative electron acceptors. Environ. ScL Technol. 2006, 40, 7034-7039.

(22) Amano F.; Suzuki S.; Yamamoto T.; Tanaka T. One electron reducibility of isolated copper oxide on alumina for selective NO—CO reaction. Appl. Catal. B. Environ. 2006, 64, 282-289.

(23) Yoon, S. H.; Lee, J. H. Oxidation mechanism of As(III) in the UV/TiO2 system: evidence for a direct hole oxidation mechanism. Environ. Sci. Technol. 2005, 39, 9695-9701.

(24) Nosaka Y.; Koenuma K.; Ushida K.; Kira A. Reaction mechanism of the decomposition of acetic acid on illuminated TiO2 powder studied by in-situ electron spin resonance measurements. Langmuir 1996, 12, 736-738.

(25) Lair, A.; Ferronato, C.; Chovelon, J. M.; Herrmann, J. M. Naphthalene degradation in water by heterogeneous photocatalysis: An investigation of the influence of inorganic anions. J. Photochem. Photobio. A.: Chem. 2008, 193, 193-203.

(26) Agrios, A.; Pichat, P. State of the art and perspectives on materials and applications of photocatalysts over TiO2. J. Appl. Electrochem. 2005, 35, 655-663.

(27) Wu, G.; Nishikawa, T.; Ohtani, B.; Chen, A. Synthesis and characterization of carbon doped TiO2 nanostructures with enhanced visible response. Chem. Mater. 2007, 19, 4530-4537.

(28) Canizares, P.; Martinez, F.; Jimenez, C.; Lobato, J.; Rodrigo, M. A. Coagulation and electrocoagulation of wastes polluted with dyes. Environ. Sci. Technol. 2006, 40, 6418-6424.

(29) Wang, J. W.; Bejan, D.; Bunce, N. J. Electrochemical methods for remediation of arsenic contaminated nickel electrorefining baths. Ind. Eng. Chem Res. 2005, 44, 3384-3388.

(30) Rodgers, J. D.; Bunce, N. J. Electrochemical treatment of 2,4,6-trinitrotoluene and related compounds. Environ. ScL Technol. 2001, 35, 406-410.

(31) Adams, B.; Tian, M.; Chen, A. Design and electrochemical study of SnO2-based mixed oxide electrodes. Electrochem. Acta 2009, 54, 1491-1498.

(32) Comninellis, C. Electrocatalysis in the electrochemical conversion/combustion of organic pollutants for waste water treatment. Electrochim. Acta 1994, 39, 1857-1862.

(33) Chen, A.; Miller, B. Potential oscillations during the electrocatalytic oxidation of sulfide on a microstructured Ti/Ta2O5-IrO2 electrode. J. Phys. Chem. B 2004, 108, 2245-2251.

(34) Miller B.; Chen, A. Effect of concentration and temperature on electrochemical oscillations during sulfide oxidation on Ti/Ta2O5-IrO2 electrodes. Electrochim. Acta 2005, 50, 2203-2212.

(35) 4-Nitrophenol Health and Environmental Effects Profiles No. 135, U.S. Environmental Protection Agency (EPA), U.S. Government Printing Office, District of Columbia, 1980.

(36) Quiroz, M. A.; Reyna, S.; Martinez-Huitle, C. A.; Ferro, S.; De Battisti, A. Electrocatalytic oxidation of p-nitrophenol from aqueous solutions at Pb/PbO2 anodes. App. Catal. B:Environ. 2005, 59, 259-266.

1. An electrode for combined photocatalytic and electrochemical remediation for removing at least first and second pollutants, said first and second pollutants being any one or combination of organic chemical pollutants, inorganic chemical pollutants and microrganisms, comprising:
a) an electronically conducting substrate having a surface;
b) a photocatalyst applied to a first portion of the surface, the photocatalyst having a bandgap energy (E_{g}); and
c) an electrocatalyst applied to a second portion of the surface, the electrocatalyst being made of a different material than the photocatalyst, the first and second portions of the surface being different from each other;
wherein insertion of said electronically conducting substrate into a liquid containing multiple pollutants, illumination of said photocatalyst with photons of energy equal to or higher than E_{g} and application of an anodic potential bias to said electronically conducting substrate results in said anodic potential bias being applied to said electrocatalyst which induces anodic oxidation of at least a first pollutant at a surface of the electrocatalyst, and a potential drop develops across a thickness of the photocatalyst causing band bending at the surface of the photocatalyst which results in separation of electrons and holes produced in said thickness, which drives holes to the surface and results in anodic oxidation reaction of at least a second pollutant.

2. The electrode according to claim 1 wherein said electrocatalyst is applied on the surface in a first pre-selected pattern, and the photocatalyst is applied to the surface in a second pre-selected pattern spaced from the first pre-selected pattern.

3. The electrode according to claim 1 wherein said electronically conducting substrate has two opposed surfaces, and wherein said electrocatalyst is applied to one of the opposed surfaces and said photocatalyst is applied to the other opposed surface.

4. The electrode according to claim 1 wherein said electronically conducting substrate is a first electronically conducting substrate having a first surface defining the first portion to which the photocatalyst is applied, the electrode including a second electronically conducting substrate having a second surface defining the second portion to which the electrocatalyst is applied, and wherein the first and second electronically conducting substrates are electrically connected together so that the anodic potential bias is applied to both said first and second electronically conducting substrates.

5. The electrode according to claim 1 wherein said photocatalyst is selected from the group consisting of metal oxides, photoconducting polymers, silicon and any combination thereof.

6. The electrode according to claim 5 wherein said metal oxide is selected from the group consisting of TiO₂, doped TiO₂, Fe₂O₃, SnO₂, ZnO, and any combination thereof.

7. The electrode according to claim 6 wherein said doped TiO₂ is doped with a dopant selected from the group consisting of carbon, nitrogen, fluorine, boron, platinum, gold, and any combination thereof.

8. The electrode according to claim 1 wherein said substrate is selected from the group consisting of metal sheets, metal plates, conducting polymers, and any combination thereof.

9. The electrode according to claim 1 wherein said substrate is flexible.

10. The electrode according to claim 1 wherein said electrocatalyst is selected from the group consisting of Ta₂O₅—IrO₂, SnO₂, Pt, RuO₂, IrO₂, carbon, PbO₂, SnO₂—Sb₂O₅, doped SnO₂—Sb₂O₅, and any combination thereof.

11. The electrode according to claim 1 wherein said photocatalyst is TiO₂ and wherein said electrocatalyst is Ta₂O₅—IrO₂.

12. The electrode according to claim 11 wherein said substrate is selected from the group consisting of titanium, tantalum, and any combination thereof.

13. The electrode according to claim 3 wherein said electronically conducting substrate is a perforated plate having a plurality of holes extending therethrough.

14. A system for wastewater remediation and water purification for removing at least first and second pollutants, the at least first and second pollutants being any one or combination of organic chemical pollutants, inorganic chemical pollutants and microrganisms, comprising:
a) a bifunctional electrode including
i) an electronically conducting substrate having a surface;
ii) a photocatalyst applied to a first portion of the surface, the photocatalyst having a bandgap energy (E_{g}); and
iii) an electrocatalyst applied to a second portion of the surface, the electrocatalyst being made of a different material than the photocatalyst, the first and second portions of the surface being different from each other;
b) a counter electrode, the bifunctional electrode and counter electrode being connected to a power supply, the power supply being configured to apply an anodic potential bias to said bifunctional electrode; and
c) a light source for emitting photons of energy equal to or higher than E_{g}, said light source being positioned with respect to said bifunctional electrode such that the portion of the surface coated with said photocatalyst is illuminated by said light source;
wherein insertion of said electronically conducting substrate into a liquid containing multiple pollutants, illumination of said photocatalyst with said light source and application of an anodic potential bias to said electronically conducting substrate results in said anodic potential bias being applied to said electrocatalyst, which induces anodic oxidation of at least a first pollutant at a surface of the electrocatalyst, and a potential drop develops across a thickness of the photocatalyst causing band bending at the surface of the photocatalyst, which results in separation of electrons and holes produced in said thickness, which drives holes to the surface and results in anodic oxidation reaction of at least a second pollutant.

15. The system according to claim 14 wherein said electrocatalyst is applied on the surface in a first pre-selected pattern, and the photocatalyst is applied to the surface in a second pre-selected pattern spaced from the first pre-selected pattern.

16. The system according to claim 14 wherein said electronically conducting substrate has two opposed surfaces, and wherein said electrocatalyst is applied to one of the opposed surfaces, and said photocatalyst is applied to the other opposed surface.

17. The system according to claim 14 wherein said electronically conducting substrate is a first electronically conducting substrate having a first surface defining the first portion to which the photocatalyst is applied, the electrode including a second electronically conducting substrate having a second surface defining the second portion to which the electrocatalyst is applied, and wherein the first and second electronically conducting substrates are electrically connected together so that the anodic potential bias is applied to both the first and second electronically conducting substrates.

18. The system according to claim 14 wherein said electronically conducting substrate is a generally cylindrically shaped pipe, said photocatalyst being coated on an outer surface of the pipe, said electrocatalyst being coated on an inner surface of the pipe, said system containing a liquid effluent flow chamber in which said pipe is located, said light source being spaced from said outer surface for illumination of the outer surface, and wherein said pipe has a longitudinal axis parallel to a flow direction of the liquid effluent such that a pollutant in the liquid effluent flowing through an interior of the pipe by the inner surface undergo anodic oxidation a pollutant in the liquid effluent flowing by the outer surface of the pipe undergo photooxidation.

19. The system according to claim 18 wherein said generally cylindrically shaped pipe includes a plurality of holes in a wall of the pipe.

20. The system according to claim 14 wherein said electronically conducting substrate is a generally cylindrically shaped pipe, said electrocatalyst being coated on an outer surface of the pipe, said photocatalyst being coated on an inner surface of the pipe, said system containing a liquid effluent flow chamber in which said pipe is located, and wherein said pipe has a longitudinal axis parallel to a flow direction of the liquid effluent, said light source being a cylindrical light source aligned along the longitudinal axis for illumination of the inner surface such that a pollutant in the liquid effluent flowing through an interior of the pipe by the inner surface undergo photooxidation and a pollutant in the liquid effluent flowing by the outer surface of the pipe undergo anodic oxidation.

21. The system according to claim 20 wherein said generally cylindrically shaped pipe includes a plurality of holes in a wall of the pipe.

22. The system according to claim 18 wherein said generally cylindrically shaped pipe is a plastic pipe having a first electrically conductive coating applied on the outer surface thereof and a second electrically conductive coating applied on the inner surface thereof, and wherein said electrocatalyst is applied to one of the first and second electrically conductive coatings and said photocatalyst is applied to the other, said power supply being electrically connected to said first and second electrically conductive coatings for applying said anodic potential bias to both said electrocatalyst and said photocatalyst.

23. The system according to claim 14 wherein said photocatalyst is selected from the group consisting of metal oxides, photoconducting polymers, silicon and any combination thereof.

24. The system according to claim 23 wherein said metal oxide is selected from the group consisting of TiO₂, doped TiO₂, Fe₂O₃, SnO₂, ZnO, and any combination thereof.

25. The system according to claim 24 wherein said doped TiO₂ is doped with a dopant selected from the group consisting of carbon, nitrogen, fluorine, boron, platinum, gold, and any combination thereof.

26. The system according to claim 14 wherein said substrate is selected from the group consisting of metal sheets, metal plates, conducting polymers, and any combination thereof.

27. The system according to claim 14 wherein said substrate is flexible.

28. The system according to claim 14 wherein said electrocatalyst is selected from the group consisting of Ta₂O₅—IrO₂, SnO₂, Pt, RuO₂, IrO₂, carbon, PbO₂, SnO₂—Sb₂O₅, doped SnO₂—Sb₂O₅, and any combination thereof.

29. A method for combined photocatalytic and electrochemical remediation for removing at least first and second pollutants, said first and second pollutants being any one or combination of organic chemical pollutants, inorganic chemical pollutants and microrganisms, the method comprising the steps of:
inserting an electrode into wastewater, the electrode comprising a substrate having a surface and having a photocatalyst applied to a first portion of the surface, the photocatalyst having a bandgap energy (E_{g}), and the electrode having an electrocatalyst applied to a second portion of the surface, the electrocatalyst being made of a different material than the photocatalyst, the first and second portions of the surface being different from each other;
illuminating the photocatalyst with photons of energy equal to or higher than E_{g} to produce electron-hole pairs in the photocatalyst; and
applying an anodic potential bias to the electrode resulting in the anodic potential bias being applied to the electrocatalyst which induces anodic oxidation of at least a first pollutant at a surface of the electrocatalyst, and a potential drop developing across a thickness of the photocatalyst causing band bending at the surface of the photocatalyst which results in separation of electrons and holes produced in said thickness, which drives holes to the surface and results in anodic oxidation of at least a second pollutant at a surface of the photocatalyst.

30. The method according to claim 29 wherein said photocatalyst is selected from the group consisting of metal oxides, photoconducting polymers, silicon, and any combination thereof.

31. The method according to claim 30 wherein said metal oxide is selected from the group consisting of TiO₂, doped TiO₂, Fe₂O₃, SnO₂, ZnO, and any combination thereof.

32. The method according to claim 31 wherein said doped TiO₂ is doped with a dopant selected from the group consisting of carbon, nitrogen, fluorine, boron, platinum, gold, and any combination thereof.

33. The method according to claim 29 wherein said substrate is selected from the group consisting of metal sheets, metal plates, metal mesh, conducting polymers, and any combination thereof.

34. The method according to claim 29 wherein said substrate is flexible.

35. The method according to claim 29 wherein said electrocatalyst is selected from the group consisting of Ta₂O₅—IrO₂, SnO₂, Pt, RuO₂, IrO₂, carbon, PbO₂, SnO₂—Sb₂O₅, doped SnO₂—Sb₂O₅, and any combination thereof.

36. The method according to claim 29 wherein said photocatalyst is TiO₂ and wherein said electrocatalyst is Ta₂O₅—IrO₂.

37. The method according to claim 36 wherein said substrate is selected from the group consisting of titanium, tantalum and any combination thereof.

38. The method according to claim 29 wherein said electrode has two opposed surfaces, and wherein said electrocatalyst is applied to one of the opposed surfaces and said photocatalyst is applied to the other opposed surface.

39. The method according to claim 38 wherein said electrode is a perforated plate having a plurality of holes extending therethrough.

40. The electrode according to claim 1 wherein a ratio of a surface area of the photocatalyst on the first portion to a surface area of the electrocatalyst on the second portion is selected to give a pre-selected reaction ratio of the anodic oxidation of said at least a first pollutant at the surface of the electrocatalyst to the anodic oxidation reaction of at least a second pollutant at the surface of the photocatalyst.

41. The electrode according to claim 1 wherein said electrocatalyst is a first electrocatalyst, including at least a second electrocatalyst located in at least a third portion of the surface, the at least a second electrocatalyst being made of a different material than the first electrocatalyst and the photocatalyst, the third portion of the surface being different from the first and second portions.

42. The electrode according to claim 41 wherein said photocatalyst is a first photocatalyst, including at least a second photocatalyst located in at least a fourth portion of the surface, the at least a second photocatalyst being made of a different material than the first and second electrocatalysts and the first photocatalyst, the fourth portion of the surface being different from the first, second and third portions.

43. The system according to claim 14 wherein a ratio of a surface area of the photocatalyst on the first portion to a surface area of the electrocatalyst on the second portion is selected to give a pre-selected reaction ratio of the anodic oxidation of said at least a first pollutant at the surface of the electrocatalyst to the anodic oxidation reaction of at least a second pollutant at the surface of the photocatalyst.

44. The method according to claim 29 wherein a ratio of a surface area of the photocatalyst on the first portion to a surface area of the electrocatalyst on the second portion is selected to give a pre-selected reaction ratio of the anodic oxidation of said at least a first pollutant at the surface of the electrocatalyst to the anodic oxidation reaction of at least a second pollutant at the surface of the photocatalyst.
